(19) United States
(12) Patent Application Publication
(10) Pub. No.: US 2026/0351639 A1
(43) Pub. Date: Nov. 5, 2026

(54) METHOD AND SYSTEM FOR REMOVING FLAMMABLE HIGH-CONCENTRATION HYDROGEN AFTER SHUTDOWN OF FUEL CELL SYSTEM OPERATION

(71) Applicant: HEESUNG CATALYSTS CORPORATION, Gyeonggi-do (KR)

(72) Inventors: Jun Hong Jeon, Gyeonggi-do (KR); Yong Sul Kim, Gyeonggi-do (KR); Seung Soo Lim, Gyeonggi-do (KR); Ji Woong Jung, Gyeonggi-do (KR); Kwi Yeon Lee, Gyeonggi-do (KR); Jin Woo Song, Gyeonggi-do (KR)

(21) Appl. No.: 19/658,901

(22) Filed: Apr. 27, 2026

(30) Foreign Application Priority Data
May 2, 2025 (KR) 10-2025-0058088

(51) Int. Cl. H01M 8/0662; H01M 8/04228; H01M 8/04303; H01M 8/0444; H01M 8/04746; H01M 8/1007

(52) U.S. Cl. CPC H01M 8/0662; H01M 8/04228; H01M 8/04303; H01M 8/04462; H01M 8/04761; H01M 8/1007

(57) ABSTRACT

Described is a method for removing flammable high-concentration hydrogen gas from residual gas after fuel cell system operation, the method including the steps of: detecting a predetermined condition in which a hydrogen concentration in residual gas is equal to or greater than a predetermined threshold after shutdown of fuel cell power generation, controlling opening of a hydrogen valve provided at an anode outlet of a fuel cell stack upon detection of the predetermined condition, supplying air to the fuel cell stack by an oxygen supply unit of the fuel cell stack, and passing the residual gas together with the supplied air through a passive hydrogen removal catalyst module provided at a downstream end of an exhaust line. Also described is a system for removing residual high-concentration hydrogen from a fuel cell stack and a hydrogen supply line after fuel cell system operation using a passive hydrogen removal catalyst.

### CROSS REFERENCE TO RELATED APPLICATION

The present application claims priority to Korean Patent Application No. 10-2025-0058088, filed May 2, 2025, the entire contents of which are incorporated herein for all purposes by this reference.

### BACKGROUND

### 1. Technical Field

The present disclosure relates to a method and a system for removing flammable hydrogen discharged to the outside after shutdown of fuel cell system operation. More specifically, the present disclosure relates to a method and a system for removing and discharging residual high-concentration hydrogen from a fuel cell stack and a hydrogen supply line after fuel cell system operation using a passive hydrogen removal catalyst.

### 2. Description of the Related Art

A fuel cell system, which is a power generation system that converts the chemical energy of a fuel into electrical energy in a fuel cell stack, is a useful system that generates electricity by reacting hydrogen, a fuel, with oxygen in the air in the fuel cell stack. However, to minimize the risk of explosion or ignition caused by hydrogen gas contained in exhaust gas discharged to the outside after power generation, the system must be controlled such that the hydrogen concentration in the exhaust gas is maintained at or below a predetermined threshold. Currently, residual gas containing high-concentration hydrogen remaining in a fuel cell stack and a hydrogen supply line after fuel cell system operation is diluted to 4vol% or less on average by air supplied by a blower or the like, and then discharged to the outside. However, noise is generated by operation of such blowers. In addition, even when high-concentration hydrogen is diluted and discharged at an average hydrogen concentration of 4%, there still exists a risk of explosion due to hydrogen concentration buildup in indoor areas of buildings, such as underground parking lots, where air circulation is difficult.

Accordingly, to dilute residual gas remaining in a fuel cell stack and a hydrogen supply line after shutdown of fuel cell system power generation, a large amount of air is required for dilution. To secure such air, the operation of a large-capacity air supply device or a plurality of small-capacity air supply devices is required. However, there is a need to address problems of noise generated by operation of such supply devices and the discharge of hydrogen to the outside at a concentration that is still capable of spontaneous ignition.

### SUMMARY

An objective of the present disclosure, which has been proposed to address problems in the related art, is to provide a method for removing and discharging residual high-concentration hydrogen from a fuel cell stack and a hydrogen supply line after fuel cell system operation.

Another objective of the present disclosure is to provide a system for removing and discharging residual high-concentration hydrogen from a fuel cell system after operation thereof, without excessive noise generated by operation of a large-capacity air supply device or a plurality of small-capacity air supply devices, to dilute the residual high-concentration hydrogen in a fuel cell stack and a hydrogen supply line.

A further objective of the present disclosure is to provide a method and a system for removing high-concentration hydrogen such that 99.99% of the residual high-concentration hydrogen is removed from a fuel cell stack and a hydrogen supply line after fuel cell system operation, thereby minimizing the risk of explosion due to hydrogen concentration buildup in enclosed areas where air circulation is difficult.

The present disclosure provides a method and a system for removing 99.99% of residual high-concentration hydrogen from a fuel cell stack and a hydrogen supply line after shutdown of fuel cell system operation, wherein a large-capacity air supply device or a plurality of small-capacity air supply devices required for hydrogen dilution is unnecessary or, even when required, is replaced with a small-capacity additional air supply device required for hydrogen oxidation, and hydrogen is removed at room temperature without a separate heat source or energy source by applying a passive hydrogen oxidation device.

Technical problems to be addressed by the present disclosure are not limited to those mentioned above, and other technical problems not mentioned can be clearly understood by those skilled in the art to which the present disclosure pertains, from the following description.

The present disclosure provides a method and a system for removing residual high-concentration hydrogen from a fuel cell system after power generation thereof.

A method for removing high-concentration hydrogen from residual gas remaining in a fuel cell stack and a hydrogen supply line after fuel cell system operation according to an embodiment of the present disclosure may include the following steps: detecting a predetermined condition in which a hydrogen concentration in residual gas is equal to or greater than a predetermined threshold after shutdown of fuel cell power generation; controlling opening of a hydrogen valve provided at an anode outlet of a fuel cell stack upon detection of the predetermined condition; supplying air to the fuel cell stack or an exhaust line by an oxygen supply unit of the fuel cell stack; and passing the residual gas together with the supplied air through a passive hydrogen removal catalyst module provided at a downstream end of the exhaust line.

The method for supplying air to the exhaust line may include supplying air, supplied to a cathode, to the exhaust line, or directly supplying air to the exhaust line via a separate valve without passing through the cathode.

When the amount of air supplied by the oxygen supply unit is less than the amount of air required for hydrogen oxidation, a sufficient amount of air may be supplied to the exhaust line by a separate additional air supply device. A small-capacity low-noise blower, an air compressor, or the like may be used as the additional air supply device, and may be connected to the exhaust line via a valve if necessary.

The amount of air required to oxidize hydrogen contained in the residual gas may be predetermined during system design. For example, when it is intended to oxidize and discharge all hydrogen contained in the residual gas within a predetermined time as exhaust gas, a corresponding hydrogen discharge rate per minute may be calculated, and the amount of air required for oxidation thereof may be calculated. Accordingly, an air supply device having an appropriate capacity may be selected. When the amount of required air is met sufficiently by the capacity of the oxygen supply unit installed in the fuel cell stack, the additional air supply device may be unnecessary. On the other hand, when the capacity of the oxygen supply unit is insufficient, the required air may be secured by the additional air supply device.

The residual gas may include air and hydrogen gas as by-products discharged from the fuel cell stack and the hydrogen supply line.

In addition, a moment at which the concentration of hydrogen gas contained in the residual gas rises to or above the predetermined threshold includes a moment when power generation of the fuel cell system is shut down. At the moment when power generation of the fuel cell system is shut down, the hydrogen valve is in a closed state, a first air valve is open toward the cathode, and a second air valve is in an open state.

A system for removing high-concentration hydrogen in residual gas from a fuel cell stack and a hydrogen supply line after fuel cell system operation according to an embodiment of the present disclosure includes: a fuel cell stack configured to generate electricity by reacting hydrogen, which is a fuel supplied to an anode through a hydrogen supply line by a hydrogen supply unit, with air, which is an oxidant supplied to a cathode via a first air valve by an oxygen supply unit; an exhaust line connected to an anode outlet of the stack via a hydrogen valve and connected to a cathode outlet thereof via a second air valve to discharge residual gas to the outside; and a passive hydrogen removal catalyst module provided at a downstream end of the exhaust line.

The passive hydrogen removal catalyst module provided in the system according to the present disclosure is filled with a hydrogen oxidation catalyst containing an active metal, platinum (Pt), or a combination of platinum (Pt) and palladium (Pd) supported on an alumina-based support.

The hydrogen oxidation catalyst according to the present disclosure may be configured in various module forms, but is preferably a honeycomb catalyst module having a carrier coated with a slurry prepared from a support on which an active metal is supported.

In the system according to the present disclosure, when the amount of air required for hydrogen oxidation in the passive hydrogen removal catalyst module is insufficiently met by the capacity of the oxygen supply unit installed in the fuel cell stack, an additional air supply device connected to the exhaust line to supply additional air required for hydrogen oxidation may be provided.

In addition, an additional air supply by the additional air supply device may be implemented by opening a valve (not shown) installed in a passage of the exhaust line, and a blower, an air compressor, or the like may be used as the additional air supply device. In the meantime, when gas is discharged from the anode and the hydrogen supply line through the exhaust line as the hydrogen valve is opened, a blower or the like for forced hydrogen discharge may be installed in the exhaust line or the fuel cell stack.

Furthermore, the specific condition may include a condition in which a moment when the concentration of hydrogen gas contained in the residual gas rises to or above a predetermined threshold occurs. Preferably, the predetermined threshold refers to a case where the average hydrogen concentration is 4 vol% or more. Additionally, as described above, even under a condition in which the average hydrogen concentration is 4% or less, a hydrogen explosion may occur due to continuous hydrogen accumulation (buildup) in enclosed areas where air circulation is difficult. For this reason, a condition in which even a small amount of hydrogen slip occurs is also included.

The above aspects of the present disclosure are only some of the preferred embodiments of the present disclosure, and various embodiments reflecting the technical features of the present disclosure may be derived and understood by those skilled in the art based on the following detailed description of the present disclosure.

Effects of a method and a system according to the present disclosure are described as follows.

The present disclosure is advantageous in that large-capacity air dilution devices configured to dilute residual high-concentration hydrogen in a fuel cell stack and a hydrogen supply line after fuel cell system operation are unnecessary, and high-concentration hydrogen can be removed and discharged solely by a hydrogen oxidation reaction without noise generated by operation of such large-capacity air dilution devices.

In addition, the present disclosure is advantageous in that residual high-concentration hydrogen can be almost completely removed from the fuel cell stack and the hydrogen supply line after fuel cell system operation, thereby minimizing the risk of explosion due to hydrogen concentration buildup in enclosed areas where air circulation is difficult.

Finally, the present disclosure uses a passive catalytic oxidation technology, which removes hydrogen through an exothermic reaction between hydrogen and oxygen at room temperature, without a separate energy source, and the exothermic reaction can be utilized as thermal energy required for the system. Thus, the present disclosure is advantageous in terms of energy efficiency.

Effects that can be achieved by the present disclosure are not limited to those mentioned above, and other effects not mentioned can be clearly understood by those skilled in the art to which the present disclosure pertains, from the following description.

### BRIEF DESCRIPTION OF THE DRAWINGS

FIG. 1 is a configuration diagram illustrating a fuel cell system according to an embodiment of the present disclosure.

FIG. 2 is a flowchart for describing a method for removing hydrogen from a fuel cell system using a passive hydrogen removal catalyst module according to an embodiment of the present disclosure.

FIG. 3 is a diagram showing hydrogen oxidation results using a platinum/palladium catalyst module.

FIG. 4 is a diagram showing hydrogen oxidation results with varying hydrogen concentrations in residual gas.

### DETAILED DESCRIPTION

Hereinafter, a system and a method to which embodiments of the present disclosure are applied are to be described in detail with reference to the attached drawings.

### Definitions

As used herein, the term "passive hydrogen oxidation catalyst" refers to a catalyst that removes hydrogen through an exothermic reaction between hydrogen and oxygen at room temperature without a separate heat source. The passive hydrogen oxidation catalyst is also referred to herein as a "hydrogen removal catalyst" and, given that hydrogen oxidation is possible at room temperature, is distinguished from an active catalyst that requires a separate energy source to enable a hydrogen oxidation reaction.

The term "catalyst module" herein is used interchangeably with a catalyst body or a shaped catalyst body, and may be configured in various forms. However, the catalyst module preferably refers to an article in which a catalyst material or a catalyst composition is shaped into a predetermined form or is supported on a carrier having a predetermined form, and the catalyst material refers to a composition in which an active material, such as a noble metal, is supported on a support having a plurality of pores. In the present disclosure, high-concentration hydrogen refers to hydrogen having a concentration of 4 vol% or more, which is capable of spontaneous ignition.

As used herein, after shutdown of fuel cell power generation, gas remaining in a hydrogen supply line and by-products of a fuel cell stack are collectively referred to as "residual gas". According to the present disclosure, high-concentration hydrogen contained in the residual gas is almost completely oxidized at room temperature to a hydrogen concentration of 0.01% or less by the passive hydrogen oxidation catalyst module, and then discharged to the outside as exhaust gas. In addition, a member connected to the outlet side of the fuel cell stack is defined as an exhaust line, which refers to the entire gas flow path connected to an anode outlet and a cathode outlet.

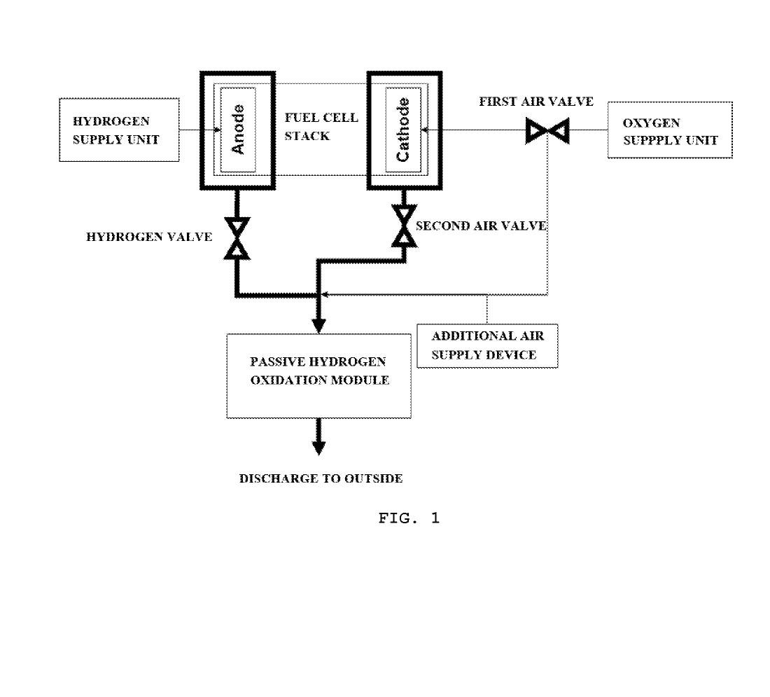

Hereinafter, the basic operation and structure of a fuel cell system are to be briefly described with reference to FIG. 1.

Referring to FIG. 1, a fuel cell system provided with a passive catalyst module for removing high-concentration hydrogen according to the present disclosure may primarily include: a fuel cell stack including an anode and a cathode; a hydrogen supply unit connected to the anode through a hydrogen supply line; an oxygen supply unit connected to the cathode via a first air valve; an exhaust line connected to an anode outlet of the stack via a hydrogen valve and connected to a cathode outlet thereof via a second air valve to discharge residual gas to the outside; an additional air supply device connected to the exhaust line to supply additional air required for hydrogen oxidation; and a passive hydrogen removal catalyst module provided at a downstream end of the exhaust line. However, the above configuration is provided for better understanding of the present disclosure, and the fuel cell system may include typical components required in fuel cell systems.

The stack generates electricity through a reaction of oxygen supplied by the oxygen supply unit with hydrogen supplied by the hydrogen supply unit. When the operation is shut down, excess air is discharged through the second air valve, and hydrogen is discharged as residual gas to the outside through the exhaust line via the hydrogen valve.

Air supplied to the exhaust line may be supplied to the exhaust line after passing through the cathode from the oxygen supply unit, and alternatively may be supplied directly to the exhaust line without passing through the cathode by operation of the first air valve.

After shutdown of fuel cell system operation, the hydrogen concentration in the residual gas may exceed a predetermined threshold. When high-concentration hydrogen gas is discharged to the outside through the exhaust line, the risk of explosion and fire may increase.

To prevent such risk, the fuel cell system provided with a device configured to remove residual high-concentration hydrogen from the fuel cell stack and the hydrogen supply line after operation, according to an embodiment of the present disclosure, may include a passive catalyst module or a hydrogen oxidation module provided at a downstream end of the exhaust line. While the passive catalyst module of the present disclosure is configured to oxidize and discharge residual high-concentration hydrogen from the fuel cell stack and the hydrogen supply line to the outside as harmless components, air required for hydrogen oxidation is supplied primarily by the oxygen supply unit connected to the cathode side. However, when additional air is required for hydrogen oxidation, an additional air supply device, such as a blower or an air compressor, may be provided to supply additional air via a valve installed in a flow path of the exhaust line, or a separate air compressor in the fuel cell system may be used.

Residual high-concentration hydrogen in the fuel cell stack and the hydrogen supply line is mixed with air required for hydrogen oxidation, resulting in a reduced hydrogen concentration. In this state, the hydrogen is decomposed by passing through the passive hydrogen oxidation module and discharged into the atmosphere.

For example, when the fuel cell system operation is shut down, a control unit (not shown) may control the additional air supply device to be turned on or off for a predetermined time. When the amount of air supplied by the oxygen supply unit is sufficient to completely oxidize gas in the stack and the hydrogen supply line through the passive catalyst module, the additional air supply device may be unnecessary. On the other hand, when the amount of air supplied by the oxygen supply unit is insufficient for hydrogen oxidation, the additional air supply device may be turned on to supply additional air required for hydrogen oxidation together with or independently of the oxygen supply unit. Air supplied by the oxygen supply unit and, if necessary, by the additional air supply device may completely oxidize high-concentration hydrogen in the residual gas, thereby significantly reducing the maximum concentration and the average concentration for unit time of hydrogen gas discharged to the outside.

A valve (not shown) for air flow by the additional air supply device according to an embodiment may be added, which may be a solenoid valve, but is not limited thereto.

In general, after the shutdown of fuel cell system operation, the concentration of hydrogen discharged through the exhaust line for 1 to 10 minutes may be significantly high. Accordingly, the system for removing hydrogen according to an embodiment of the present disclosure may control the hydrogen valve, the oxygen supply unit, and the additional air supply device at a specific time point and/or under a specific condition so that hydrogen gas having a concentration equal to or greater than the predetermined threshold is not discharged through the exhaust line. In this case, the specific time point and/or the specific condition may include a time point at which system operation is completely stopped and a time point at which system operation is temporarily stopped. However, these are merely examples, and it should be noted that the control timing may be adaptively set differently depending on the characteristics and structure of the corresponding fuel cell system.

The fuel cell system according to the present disclosure uses the passive hydrogen oxidation catalyst module to reduce the high concentration of hydrogen. Specifically, a catalyst module in which a honeycomb-shaped body is coated either partially or entirely with a catalyst slurry prepared by supporting an active metal, platinum, or a combination of platinum and a palladium precursor on an alumina-based support, such as alumina, is used. The honeycomb-shaped body, serving as a catalyst material carrier, includes a plurality of through-cells having substantially square cross-sections. The through-cells are formed regularly along a longitudinal direction, and each of the through-cells is partitioned by thin cell walls. The surfaces of the cell walls or the insides of pores thereof are coated with the catalyst material. Alternatively, the catalyst material is supported on the surfaces of the cell walls or inside the pores thereof. Specifically, platinum, or a combination of platinum and palladium as noble metals, is supported on the cell walls of the shaped body in an amount of 60 g/ft³. The optimal loading amount of the noble metal may vary depending on the concentration and amount of hydrogen in the residual gas, time required for hydrogen removal, and the like.

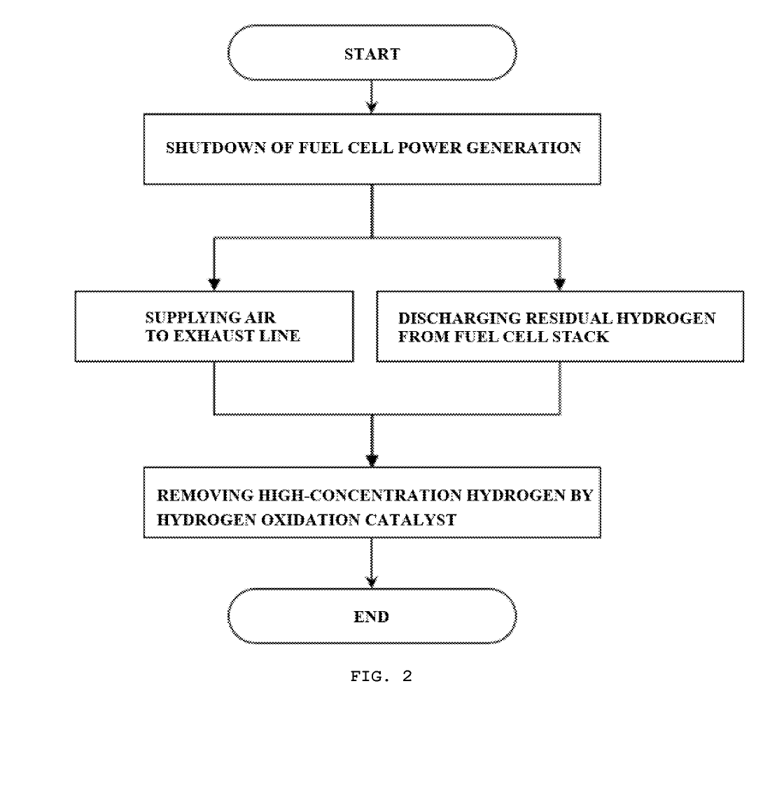

FIG. 2 is a flowchart for describing the method for removing high-concentration hydrogen gas from the residual gas using the passive hydrogen oxidation catalyst in the fuel cell system, and the operation process thereof according to an embodiment of the present disclosure.

According to the related art, in order to dilute and discharge high-concentration hydrogen in residual gas in a stepwise manner to the outside, multiple dilution processes using a blower or the like are required. However, noise generated by excessive operation of such dilution devices is unavoidable. In addition, even after such multiple dilution processes, hydrogen is discharged at an average concentration of about 4 vol%, which is relatively high. When it is intended to further reduce the concentration of discharged hydrogen, additional dilution processes are required. The inventors of the present disclosure have proposed the method for removing hydrogen by hydrogen oxidation, rather than diluting and discharging high-concentration hydrogen, given that the amount of air required to completely oxidize 100% of hydrogen is only about 1/40 of the amount of air required to dilute hydrogen to 1 vol%.

FIG. 2, which schematically illustrates the method using the system for removing residual high-concentration hydrogen gas from the fuel cell stack and the hydrogen supply line according to the present disclosure, discloses a method for achieving complete oxidation of excess hydrogen by passing residual gas containing high-concentration hydrogen in the fuel cell stack and the hydrogen supply line, together with a sufficient amount of air, through the hydrogen oxidation catalyst module after shutdown of the fuel cell system.

Specifically, the method may include the following steps: detecting a predetermined condition in which a hydrogen concentration in the residual gas is equal to or greater than a predetermined threshold after shutdown of fuel cell power generation; controlling opening of the hydrogen valve provided at the anode outlet of the fuel cell stack upon detection of the predetermined condition; supplying air to the fuel cell stack and/or the exhaust line by the oxygen supply unit of the fuel cell stack; and passing the residual gas together with the supplied air through the passive hydrogen removal catalyst module provided at a downstream end of the exhaust line.

In the method according to the present disclosure, the step of discharging hydrogen by controlling the opening of the hydrogen valve and the step of supplying air to the fuel cell stack and/or the exhaust line may be performed either in parallel or sequentially.

In addition, the specific condition includes a moment at which the power generation of the fuel cell system is stopped while the concentration of hydrogen gas contained in the residual gas is equal to or greater than the predetermined threshold. When the operation of the fuel cell system is stopped, the hydrogen valve at the anode outlet side of the fuel cell is in a closed state, and the first and second air valves at the respective inlet and outlet sides of the cathode are in an open state such that air supplied from the air supply unit can flow to the exhaust line through the cathode.

Air required for hydrogen oxidation is primarily supplied by the oxygen supply unit. However, when an additional amount of air is required, the additional air supply device connected to the exhaust line, such as a blower or an air compressor, may be operated. Specifically, when the hydrogen valve is opened in accordance with the amount of oxygen supplied by the oxygen supply unit, it may take a considerable amount of time to discharge hydrogen completely from the fuel cell stack. In this case, to shorten the discharge time, the amount of air supplied to the exhaust line through the additional air supply device may be increased, and the amount of hydrogen discharged through control of the hydrogen valve may be increased, thereby controlling the discharge time of residual hydrogen. Hydrogen may be discharged to the exhaust line due to a difference between the pressure of hydrogen in the fuel cell stack and the pressure of the exhaust line. However, a forced discharge device may be provided in the fuel cell stack or the exhaust line to facilitate hydrogen discharge. In addition, air supplied by the oxygen supply unit after shutdown of fuel cell operation is primarily supplied to the exhaust line through the fuel cell stack, but may be supplied directly to the exhaust line by closing the first air valve.

According to the present disclosure, high-concentration hydrogen in the residual gas is removed by hydrogen oxidation, unlike the related art, in which hydrogen is simply diluted and discharged to the outside. Since hydrogen oxidation does not require as much air as that required in the above dilution process, a small-capacity blower or air compressor may be used as the additional air supply device.

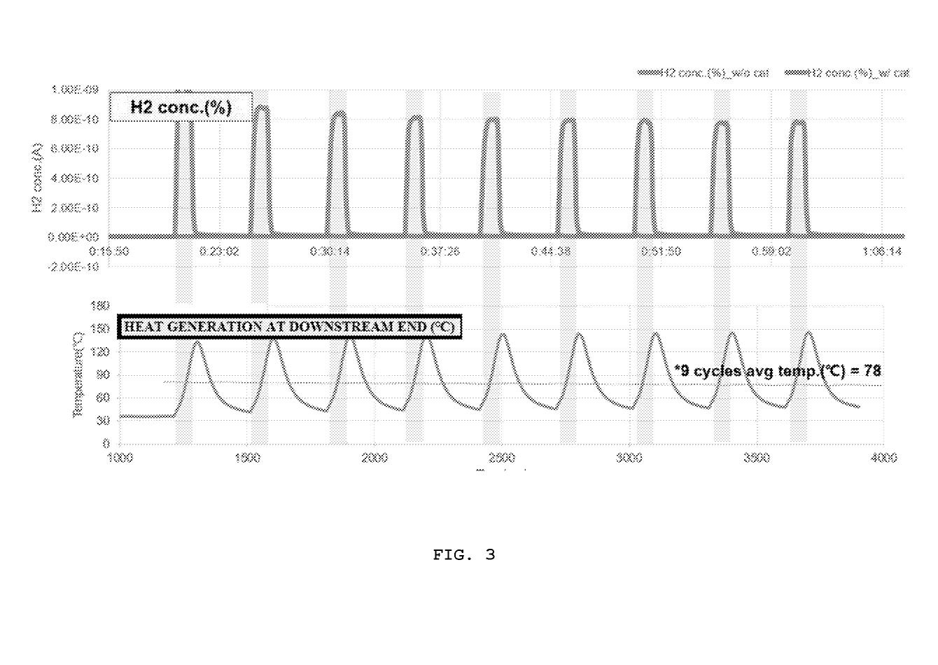

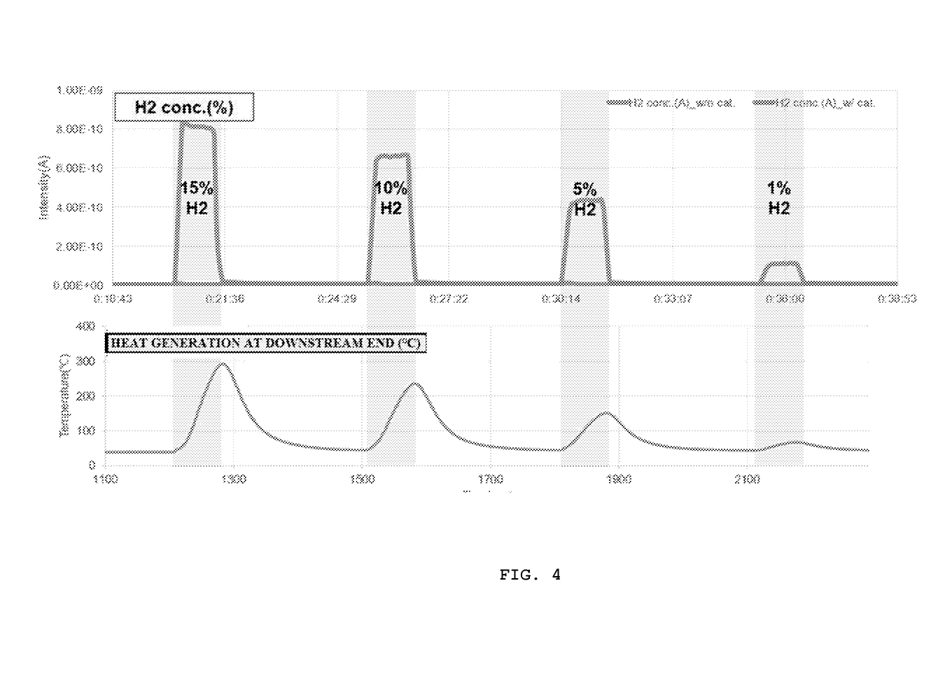

FIG. 3 shows hydrogen oxidation results using a platinum/palladium catalyst module, and FIG. 4 shows hydrogen oxidation results with varying hydrogen concentrations in residual gas.

Referring to FIG. 3, when residual gas having a hydrogen concentration of 12 vol% is passed nine times through the passive hydrogen oxidation catalyst module filled with a catalyst containing platinum and palladium (at a weight ratio of 10:1) as active metals supported at 2.5 wt% on an alumina support, heat generation at a downstream end of the module can be confirmed, indicating that 12% of hydrogen in the residual gas was almost completely oxidized. In addition, the measurement results of hydrogen concentration at upstream and downstream ends of the catalyst module using a mass spectrometer confirmed that the hydrogen concentration at the downstream end of the catalyst module was less than 0.01%. In the meantime, referring to FIG. 4, heat generation temperature data obtained when the hydrogen concentration in the residual gas was varied to 1, 5, 10, and 15% also confirm, based on mass spectrometer data, that residual gas having a hydrogen concentration in the range of 1 to 15% was oxidized by 99.99% by the system and method according to the present disclosure.

Additionally, while the present disclosure has been described hereinabove with reference to preferred embodiments, it will be understood by those skilled in the art that various modifications and changes may be made without departing from the idea and scope of the present disclosure as defined in the appended claims.

What is claimed is:

1. A method for removing flammable high-concentration hydrogen gas from residual gas after fuel cell system operation, the method comprising:
detecting a predetermined condition in which a hydrogen concentration in residual gas is equal to or greater than a predetermined threshold after shutdown of fuel cell power generation;
controlling opening of a hydrogen valve provided at an anode outlet of a fuel cell stack upon detection of the predetermined condition;
supplying air to the fuel cell stack by an oxygen supply unit of the fuel cell stack; and
passing the residual gas together with the supplied air through a passive hydrogen removal catalyst module provided at a downstream end of an exhaust line.

2. The method of claim 1, further comprising:
supplying additional air by an additional air supply device connected to the exhaust line after the supplying of the air to the fuel cell stack by the oxygen supply unit of the fuel cell stack.

3. A system for removing flammable high-concentration hydrogen gas from residual gas after fuel cell system operation, the system comprising:
a fuel cell stack configured to generate electricity by reacting hydrogen, which is a fuel supplied to an anode by a hydrogen supply unit, with air, which is an oxidant supplied to a cathode via a first air valve by an oxygen supply unit;
an exhaust line connected to an anode outlet of the stack via a hydrogen valve and connected to a cathode outlet thereof via a second air valve to discharge residual gas to the outside; and
a passive hydrogen removal catalyst module provided at a downstream end of the exhaust line.

4. The system of claim 3, further comprising:
an additional air supply device connected to the exhaust line and configured to supply additional air required for hydrogen oxidation.

5. The system of claim 3, wherein the passive hydrogen removal catalyst module is filled with a hydrogen oxidation catalyst comprising an active metal, platinum (Pt), or a combination of platinum (Pt) and palladium (Pd) supported on an alumina-based support.

6. The system of claim 3, wherein the passive hydrogen
removal catalyst module is provided as a honeycomb catalyst module having a carrier coated with a slurry composition of a hydrogen oxidation catalyst, the slurry composition comprising an active metal, platinum (Pt), or a combination of platinum (Pt) and palladium (Pd) supported on an alumina-based support.
